(19) United States
(12) Patent Application Publication
(10) Pub. No.: US 2025/0150323 A1
(43) Pub. Date: May 8, 2025

(54) Method and Apparatus for Determining Alarm Flood Cause

(71) Applicant: Telefonaktiebolaget LM Ericsson (publ), SE-164 83 (SE)

(72) Inventors: Xiaoting Liang, Guangzhou, Guangdong (CN); Min Liu, Guangzhou, Guangdong (CN); Huaziong Xu, Guangzhou, Guangdong (CN)

(21) Appl. No.: 18/834,117

(22) PCT Filed: Jan. 29, 2022
(86) PCT No.: PCT/CN2022/075009

§ 371 Date: Jul. 29, 2024

(51) Int. Cl. H04L 41/0631; H04L 41/16

(52) U.S. Cl. CPC H04L 41/0631; H04L 41/16

(57) ABSTRACT

A method and apparatus for determining alarm flood cause are disclosed. A method performed by a network node comprises obtaining alarm data comprising a specific type of alarm (302); detecting an alarm flood of the alarm data (304); obtaining data from at least one vendor related to the alarm data (306); determining at least one root cause of the alarm flood of alarm data based on the data from at least one vendor and the alarm data (308).

### TECHNICAL FIELD

The non-limiting and exemplary embodiments of the present disclosure generally relate to the technical field of communications, and specifically to methods and apparatuses for determining alarm flood cause.

### BACKGROUND

This section introduces aspects that may facilitate a better understanding of the disclosure. Accordingly, the statements of this section are to be read in this light and are not to be understood as admissions about what is in the prior art or what is not in the prior art.

To ensure quality of services, there may be a centralized fault management system to manage alarms from various sources such as the network elements (NE) in a communication network. For example, in long term evolution (LTE) radio access network (RAN), fault management system may manage the alarms from evolved Node Bs (eNBs).

There may be various alarms. For example, HBF (HeartBeat Failure) alarm is one of alarms in a communication network. Heartbeat is to check a health of NE and a communication between NEs and NMS (Network Management System), by receiving or polling heartbeat of a target NE within a predefined time interval. If no heartbeat is received from a NE, it might indicate that the NE cannot provide service anymore and a HBF alarm may be generated and reported on the NMS.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

The alarm such as HBF can be caused by many prospects, including transmission, power outage, software or hardware failure of NE, wrong configuration, bad weather such as storm, earthquake, etc.

Fault management system sometimes suffers from alarm flood, which means lots of alarms occurring in a short period.

Alarm flood brings many challenges to the network operators because it indicates many NEs may not provide service anymore, which is much more serious than a single alarm. Hence, understanding the context and identifying a remedy action quickly is crucial. However, manual analyzing the alarms one by one is time consuming and labor-intensive work.

The alarm flood has become a challenge to the network operators because human could not identify a root cause and evaluate the impact to the end users quickly and accurately.

There are many existing approaches to handle alarm flood, which are summarized as below.

Rule based techniques are a traditional technique, where engineers manually define the rules for alarm reduction and correlation based on their empirical knowledge. These rules are usually accurate and can help to reduce the alarm number as well as assisting root cause analysis.

The idea of pattern analysis based techniques is that advanced data mining algorithms can extract useful patterns that can be used to formalize alarm suppression rules. For example, Y. Laumonier, J. -. Faure, J. -. Lesage and H. Sabot, “Towards alarm flood reduction”, 22nd IEEE International Conference on Emerging Technologies and Factory Automation (ETFA), 2017, pp. 1-6, uses a pattern mining algorithm on alarm sequences to detect frequent patterns composed of adjacent alarms. Once the frequent patterns are detected, they are validated by an expert to check whether some alarms of the patterns are redundant and should be removed. G. Dorgo and J. Abonyi, “Sequence Mining Based Alarm Suppression,” in IEEE Access, vol. 6, pp. 15365-15379, 2018, proposes a multi-temporal sequence mining-based algorithm to detect related alarms and develop suppression rules.

The idea of priority rating based techniques is that representative or severe alarms are extracted from the alarm flood and recommended to the engineers to save engineers' effort in diagnosing problem. For example, N. Zhao et al., “Understanding and Handling Alert Storm for Online Service Systems”, IEEE/ACM 42nd International Conference on Software Engineering: Companion Proceedings (ICSE-Companion), 2020, pp. 262-263, proposes AlertRank, an automatic and adaptive framework for identifying severe alerts. Specifically, AlertRank extracts a set of powerful and interpretable features (textual and temporal alert features, univariate and multivariate anomaly features for monitoring metrics), adopts XGBoost ranking algorithm to identify the severe alerts out of all incoming alerts. N. Zhao et al., “Automatically and Adaptively Identifying Severe Alerts for Online Service Systems”, IEEE International Conference on Computer Communications, 2020, pp. 2420-2429, proposes an alarm storm summary approach to extract the representative alarms from numerous alarms. This approach includes three steps: learning-based alert denoising, clustering-based alert discrimination, and representative alert selection.

The idea of causal model based techniques is to learn a causal model that represents the relationships between the alarms. This allows alarm sequences that are causally implied to be reduced to the root cause alarm. For example, P. Wunderlich and O. Niggemann, “Structure learning methods for Bayesian networks to reduce alarm floods by identifying the root cause”, 22nd IEEE International Conference on Emerging Technologies and Factory Automation (ETFA), 2017, pp. 1-8, uses Bayesian networks to model the causes of alarms and to help the expert interpretation thanks to a graphical representation.

There are some difficulties in alarm flood cause isolation in a communication network, for example HBF alarm flood cause isolation.

The network is heterogeneous. The NEs can be provided by different software and/or hardware technologies, by multiple vendors, in different locations and different environments. The alarm such as heartbeat failure can be caused by many different root causes.

The NEs' relationship is complex. Normally, the network structure is hierarchical, like a tree. If the core network has no problem, the edge node's behavior may be independent, otherwise their behaviors may be dependent, such as transportation network issue, power grid issue, wrong batch configuration change, etc.

Usually, the problem is transient, which is hard to be reproduced.

The aforementioned techniques mainly use the alarm suppression or root cause alarm correlation approaches to address the problem of alarm flood. However, which have following limitations.

Existing techniques have very strong assumption that the root cause of the alarm flood is observable in the alarm data. Thus, the focus of existing techniques is to recommend the most correlative alarm set to engineers for further diagnosis. However, the root cause of the alarm flood might not always be caught by the alarm data. For example, the HBF alarm flood may be caused by various factors such as transportation network, bad weather, power outage, configuration change, upgrade and so on. There might not be any alarm to raise for these events. Therefore, only examining the alarm data is not sufficient to isolate the root cause of the alarm flood.

Existing techniques rely on the temporal and spatial data analysis to derive the suppression rule or casual model. Such techniques are only appropriate to tight coupled scenarios, such as alarm flood coming from a same NE (such as eNB) in the network (such as LTE). But in practice, we usually face the alarm flood coming from a large set of NEs (e.g., eNBs), so named as loosely coupled scenario. As each NE is relatively independency, it is difficult to explore the alarm relationship across different NEs. Thus, existing techniques are not appropriate to such loosely coupled scenario.

In large-scale network (such as LTE RAN), NEs (e.g., eNBs) interact with many other NEs. The HBF alarm indicates an e2e (end to end) failure. Not all monitoring data from all NEs is available due to “Isolated Island of Data” problem. Alarm flood could be caused by other NEs rather than NE itself. And those NEs may be provided by multiple vendors. Failure root cause, sometimes, even for monitoring data from these products is not available. Existing techniques do not cover the failure from 3rd party products. So, if alarm flood is caused by the failure of a 3rd party product, existing techniques will lose the insight to it.

In summary, there are still significant challenges for handling the alarm flood (such as HBF alarm flood) in a communication network. Some major challenges are listed as below.

A first challenge is that individual alarm cannot always explain the root cause of the alarm flood. Hence, the network level insight may be required.

A second challenge is that alarm flood in loosely coupled scenario cannot be fully supported.

A third challenge is that there is a lack of insight of the failure for 3rd party products.

In a communication network, alarm flood (such as HBF alarm flood) may be very common, and the root cause of alarm flood is usually difficult to be isolated based on only the alarm data or single NE's monitoring data.

To overcome or mitigate at least one above mentioned problems or other problems, an improved solution for determining alarm flood cause may be desirable.

In an embodiment, an automatic and adaptive framework is proposed to handle the alarm flood (such as HBF alarm flood).

In the proposed solution, it formulates the alarm flood cause isolation problem as a pattern mining problem. Given an alarm flood is detected over a period of time, the goal is to search for the pattern set (also named effective pattern combinations) that can characterize the alarm flood. It may integrate data collection, anomaly detection, pattern data generation and cause isolation to provide an e2e solution for alarm flood cause isolation. More specifically, in the stage of data collection, it provides a smart and effective data collection mechanism, which covers various data sources from multiple vendors. And in the stage of cause isolation, it uses an intelligent search algorithm to reduce the search space and an effective ranking algorithm to select the most correlated effective pattern combinations.

In a first aspect of the disclosure, there is provided a method performed by a network node. The method comprises obtaining alarm data comprising a specific type of alarm. The method further comprises detecting an alarm flood of the alarm data. The method further comprises obtaining data from at least one vendor related to the alarm data. The method further comprises determining at least one root cause of the alarm flood of alarm data based on the data from at least one vendor and the alarm data.

In an embodiment, detecting an alarm flood of alarm data comprises at least one of detecting the alarm flood of alarm data based on a threshold, or detecting the alarm flood of alarm data based on a machine learning algorithm.

In an embodiment, the alarm data comprises alarm data of a communication network.

In an embodiment, the alarm data of the communication network comprises heart beat failure alarm data.

In an embodiment, obtaining data from at least one vendor related to the alarm data comprises at least one of obtaining the data from the at least one vendor related to the alarm data regularly, or obtaining the data from the at least one vendor related to the alarm data when the alarm flood of the alarm data is detected.

In an embodiment, the data from the at least one vendor comprises at least one of network device configuration data, network device diagnosis result, network data, or environment data.

In an embodiment, the network device configuration data comprises at least one of network device type, network device geographical information, network device property, network device scene property, electricity motor room that a network device is connected to, project that a network device belongs to, network device network mode, network device installation date, network device transmission mode, network device remote radio unit type, network device version, building that covered by a network device, or a distance between a network device and nearest coastline.

In an embodiment, the network device geographical information comprises at least one of a city that a network device locates, a district that a network device locates, or a geographical cluster identifier of a network device.

In an embodiment, the network data comprises at least one of network diagnosis log, an identity of a default router of a network device, or a name of a network management system that performs alarm data detection.

In an embodiment, the network diagnosis log comprises node information in a path obtained by a network measurement tool.

In an embodiment, the network device comprises a base station.

In an embodiment, the environment data comprises at least one of a precipitation level, a wind level, or a temperature level.

In an embodiment, the network device diagnosis result comprises at least one of a network device diagnosis result during an alarm active period, or a network device diagnosis result during an alarm ceased period.

In an embodiment, the network device diagnosis result during the alarm active period comprises at least one of maintenance work checking of a network device, construction work checking of a network device, default router status checking of a network device, or traffic status checking in neighbor network device.

In an embodiment, the network device diagnosis result during the alarm ceased period comprises at least one of software crash event checking of a network device, restart event checking of a network device, upgrade event checking of a network device, local transmission issue checking of a network device, or remote transmission issue checking of a network device.

In an embodiment, determining at least one root cause of the alarm flood of alarm data based on the data from at least one vendor and the alarm data comprises generating respective list of pattern data for at least one alarm based on the data from at least one vendor and the alarm data and based on the respective list of pattern data for at least one alarm, determining at least one pattern data combination that can characterize the alarm flood of the alarm data as the at least one root cause of the alarm flood of alarm data.

In an embodiment, the pattern data has a uniform format or is processed into the uniform format.

In an embodiment, determining the pattern data combination comprises determining respective score of respective candidate pattern combination based on a distribution difference of the respective candidate pattern combination between normal period data and abnormal period data as well as an distribution of the respective candidate pattern combination in the abnormal period data and based on the respective score of respective candidate pattern combination, determining at least one pattern data combination with a score above a threshold as the at least one root cause of the alarm flood of alarm data.

In an embodiment, determining the pattern data combination further comprises at least one of filtering out irrelevant pattern combination by using abnormal period data; filtering out pattern combination with a low frequency of occurrence; or filtering out redundant pattern data from the at least one pattern data combination based on redundant relationship of a pair of pattern data.

In a second aspect of the disclosure, there is provided network node. The network node comprises a processor and a memory coupled to the processor. Said memory contains instructions executable by said processor. Said network node is operative to obtain alarm data comprising a specific type of alarm. Said network node is further operative to detect an alarm flood of the alarm data. Said network node is further operative to obtain data from at least one vendor related to the alarm data. Said network node is further operative to determine at least one root cause of the alarm flood of alarm data based on the data from at least one vendor and the alarm data.

In a third aspect of the disclosure, there is provided a network node. The network node comprises a first obtaining module configured to obtain alarm data comprising a specific type of alarm. The network node further comprises a detecting module configured to detect an alarm flood of the alarm data. The network node further comprises a second obtaining module configured to obtain data from at least one vendor related to the alarm data. The network node further comprises a determining module configured to determine at least one root cause of the alarm flood of alarm data based on the data from at least one vendor and the alarm data.

In a fourth aspect of the disclosure, there is provided a computer program product comprising instructions which, when executed on at least one processor, cause the at least one processor to carry out any of the method according to the first aspect of the disclosure.

In a fifth aspect of the disclosure, there is provided a computer-readable storage medium storing instructions which, when executed on at least one processor, cause the at least one processor to carry out any of the method according to the first aspect of the disclosure.

Embodiments herein afford many advantages, of which a non-exhaustive list of examples follows. In some embodiments herein, the proposed solution has effectiveness. The proposed solution doesn't seek to use single data source from single vendor to explain the root cause of an alarm flood (such as HBF alarm flood). Instead, it provides a data collection framework to adopt different data source from different vendors. This overcomes the weakness that single data source may not be able to explain a certain alarm flood (such as HBF alarm flood). The framework leverages the knowledge from different domains, which can identify root cause more accurately.

In some embodiments herein, the proposed solution has efficiency. The proposed solution adopts numerous data for cause isolation. This will result in a very large root cause search space. Manually analysis for these huge data is impossible. The proposed solution introduces a high-efficiency cause isolation model to analyze the data. It only requires a few seconds for the root cause analysis, which highly reduces the human effort and time of trouble shooting.

In some embodiments herein, the proposed solution has applicability. The proposed solution provides a general framework for alarm flood cause isolation in loosely coupled scenario. The framework once built up, can be reused by various alarm/KPI/event anomaly flood with just re-defining the type of alarm/KPI/event anomaly flood to monitor and some of data source for effective pattern combinations searching.

The embodiments herein are not limited to the features and advantages mentioned above. A person skilled in the art will recognize additional features and advantages upon reading the following detailed description.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 shows an example of architecture according to an embodiment of the present disclosure;

FIG. 2 shows an example of functions and workflow in FA according to an embodiment of the present disclosure;

FIG. 3 shows a flowchart of a method according to an embodiment of the present disclosure;

FIG. 4 shows an example of eNB diagnosis actions according to an embodiment of the present disclosure;

FIG. 5 shows an example of a telecommunication network according to an embodiment of the present disclosure;

FIG. 6 shows an example of data collection call flow according to an embodiment of the present disclosure;

FIG. 7 shows an example of structure of the pattern data after consolidation according to an embodiment of the present disclosure;

FIG. 8 shows an flowchart of cause isolation model according to an embodiment of the present disclosure;

FIG. 9 is a block diagram showing an apparatus suitable for practicing some embodiments of the disclosure; and

FIG. 10 is a block diagram showing a network node according to an embodiment of the disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure.

Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “network” refers to a network following any suitable communication standards such as new radio (NR), long term evolution (LTE), LTE-Advanced, wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. A CDMA network may implement a radio technology such as Universal Terrestrial Radio Access (UTRA), etc. UTRA includes WCDMA and other variants of CDMA. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, Ad-hoc network, wireless sensor network, etc. In the following description, the terms “network” and “system” can be used interchangeably. Furthermore, the communications between two devices in the network may be performed according to any suitable communication protocols, including, but not limited to, the communication protocols as defined by a standard organization such as 3rd Generation Partnership Project (3GPP). For example, the communication protocols may comprise the first generation (1G), 2G, 3G, 4G, 4.5G, 5G communication protocols, and/or any other protocols either currently known or to be developed in the future.

The term “network device” or “network node” or “network function (NF)” refers to any suitable function which can be implemented in a network element (physical or virtual) of a communication network. For example, the network function can be implemented either as a network element on a dedicated hardware, as a software instance running on a dedicated hardware, or as a virtualized function instantiated on an appropriate platform, e.g. on a cloud infrastructure. For example, the 5G system (5GS) may comprise a plurality of NFs such as AMF (Access and mobility Function), SMF (Session Management Function), AUSF (Authentication Service Function), UDM (Unified Data Management), PCF (Policy Control Function), AF (Application Function), NEF (Network Exposure Function), UPF (User plane Function) and NRF (Network Repository Function), RAN (radio access network), SCP (service communication proxy), NWDAF (network data analytics function), NSSF (Network Slice Selection Function), NSSAAF (Network Slice-Specific Authentication and Authorization Function), etc.

In a wireless communication network, the network device may refer to a base station (BS), an IAB (Integrated Access and Backhaul node), an access point (AP), a multi-cell/multicast coordination entity (MCE), a controller or any other suitable device. The BS may be, for example, a node B (NodeB or NB), IAB node, an evolved NodeB (eNodeB or eNB), a next generation NodeB (gNodeB or gNB), a remote radio unit (RRU), a radio header (RH), a remote radio head (RRH), a relay, a low power node such as a femto, a pico, and so forth.

Yet further examples of the network device comprise multi-standard radio (MSR) radio equipment such as MSR BSs, network controllers such as radio network controllers (RNCs) or base station controllers (BSCs), base transceiver stations (BTSs), transmission points, transmission nodes, positioning nodes and/or the like. More generally, however, the network node may represent any suitable device (or group of devices) capable, configured, arranged, and/or operable to enable and/or provide a terminal device access to a wireless communication network or to provide some service to a terminal device that has accessed to the wireless communication network.

The network function (NF) can be implemented in a network element (physical or virtual) of a communication network. For example, the network node can be implemented either as a network element on a dedicated hardware, as a software instance running on a dedicated hardware, or as a virtualized function instantiated on an appropriate platform, e.g. on a cloud infrastructure.

Virtualizing means creating virtual versions of apparatuses or devices which may include virtualizing hardware platforms, storage devices and networking resources. As used herein, virtualization can be applied to a provider edge node and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments hosted by one or more of hardware nodes. Further, in embodiments in which the virtual node is not a radio access node or does not require radio connectivity (e.g., a core network node), then the provider edge node or PE may be entirely virtualized.

The functions may be implemented by one or more applications (which may alternatively be called software instances, virtual appliances, network functions, virtual nodes, virtual network functions, etc.) operative to implement some of the features, functions, and/or benefits of some of the embodiments disclosed herein. Applications are run in virtualization environment which provides hardware comprising processing circuitry and memory. Memory contains instructions executable by processing circuitry whereby application is operative to provide one or more of the features, benefits, and/or functions disclosed herein.

Virtualization environment, comprises general-purpose or special-purpose network hardware devices comprising a set of one or more processors or processing circuitry, which may be commercial off-the-shelf (COTS) processors, dedicated Application Specific Integrated Circuits (ASICs), or any other type of processing circuitry including digital or analog hardware components or special purpose processors. Each hardware device may comprise memory which may be non-persistent memory for temporarily storing instructions or software executed by processing circuitry. Each hardware device may comprise one or more network interface controllers (NICs), also known as network interface cards, which include physical network interface. Each hardware device may also include non-transitory, persistent, machine-readable storage media—having stored therein software and/or instructions executable by processing circuitry. Software may include any type of software including software for instantiating one or more virtualization layers (also referred to as hypervisors), software to execute virtual machines as well as software allowing it to execute functions, features and/or benefits described in relation with some embodiments described herein.

Virtual machines, comprise virtual processing, virtual memory, virtual networking or interface and virtual storage, and may be run by a corresponding virtualization layer or hypervisor. Different embodiments of the instance of virtual appliance may be implemented on one or more of virtual machines, and the implementations may be made in different ways.

During operation, processing circuitry executes software to instantiate the hypervisor or virtualization layer, which may sometimes be referred to as a virtual machine monitor (VMM). Virtualization layer may present a virtual operating platform that appears like networking hardware to virtual machine.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, the phrase “at least one of A and B” or “at least one of A or B” should be understood to mean “only A, only B, or both A and B.” The phrase “A and/or B” should be understood to mean “only A, only B, or both A and B”.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

It is noted that some embodiments of the present disclosure are mainly described in relation to the cellular network as defined by 3GPP being used as non-limiting examples for certain exemplary network configurations and system deployments. As such, the description of exemplary embodiments given herein specifically refers to terminology which is directly related thereto. Such terminology is only used in the context of the presented non-limiting examples and embodiments, and does naturally not limit the present disclosure in any way. Rather, any other system configuration or radio technologies may equally be utilized as long as exemplary embodiments described herein are applicable.

It is noted that some embodiments of the present disclosure are mainly described in relation to HBF alarm flood being used as non-limiting examples. The proposed solution may equally be applied to any other suitable alarm/event/KPI (Key Performance Indicator) flood as long as exemplary embodiments described herein are applicable.

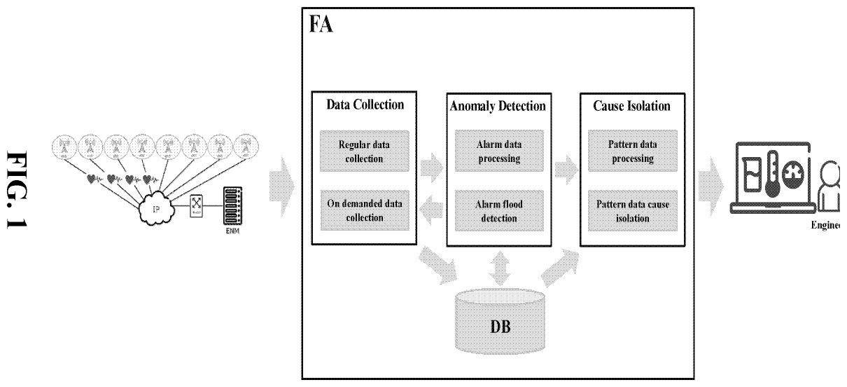

FIG. 1 shows an example of architecture according to an embodiment of the present disclosure.

The proposed architecture, named FA (Failure Analytic), may comprise three components: data collection module, anomaly detection module and cause isolation module.

FA is designed to detect and analyze various alarm flood (such as HBF alarm flood) in a network (such as communication network). It supports various data collection tasks for retrieving required data from multiple vendors. The data collection can be triggered regularly or on demand. For the on demand data collection, it will be initiated when alarm flood is detected.

FA has an anomaly detection module for alarm flood detection. In order to adapt different user requirements, FA may provide two options for detecting alarm flood: threshold-based method and machine learning (ML) algorithm-based method. The threshold-based method allows users to define fixed threshold based on their preference, while ML algorithm-based method provides a self-adaptive algorithm to automatically detect the alarm flood.

When an alarm flood is detected and all data have been collected, it will trigger the auto cause isolation module to further localize the possible root cause. In the stage of cause isolation, FA may retrieve various pattern data and process them into uniform format. The pattern data is then fed into the cause isolation model, where a cause isolation algorithm is performed to search the most possible root cause.

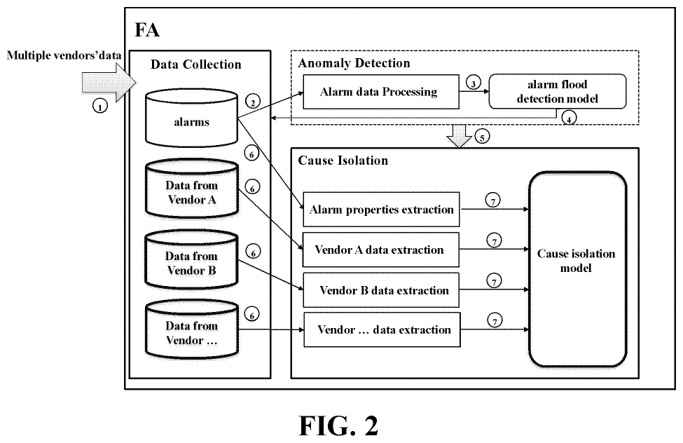

FIG. 2 shows an example of functions and workflow in FA according to an embodiment of the present disclosure.

At step 1. Regularly data collection from multiple vendors are performed by the data collection module. The collected data may be stored in the database of FA.

At step 2. Anomaly detection module retrieves the alarm data (such as HBF alarm data) from the database and process them.

At step 3. The processed alarm data is sent to an alarm flood detection model for alarm flood detection.

At step 4. If the alarm flood is detected, it may trigger on demand data collection from multiple vendors.

At step 5. The anomaly detection module sends the alarm flood detection result to the cause isolation module.

At step 6. Cause isolation module retrieves all the available pattern data from the database and process them into uniform format.

At step 7. The pattern data is sent to the cause isolation model for analysis and a final result will be returned.

The detailed information for each module will be described in following.

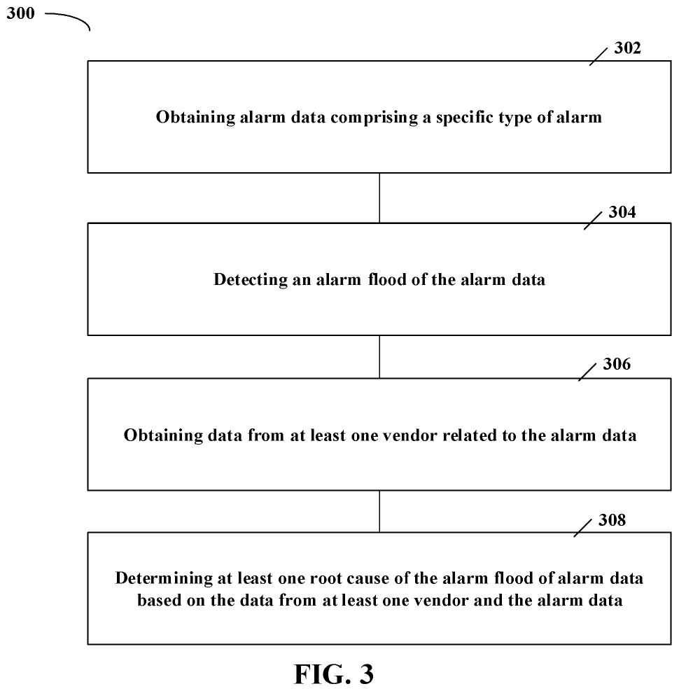

FIG. 3 shows a flowchart of a method according to an embodiment of the present disclosure, which may be performed by an apparatus implemented in or at or as a network node or communicatively coupled to the network node. As such, the apparatus may provide means or modules for accomplishing various parts of the method 300 as well as means or modules for accomplishing other processes in conjunction with other components.

The network node can be a virtual instance/functionality. In an embodiment, the network node may be a network management node or an alarm management node. In an embodiment, the network node may be or comprise the FA as shown in FIGS. 1-2.

At block 302, the network node may obtain alarm data comprising a specific type of alarm. For example the data collection module of FA of FIGS. 1-2 may obtain alarm data comprising a specific type of alarm.

The alarm data may be any suitable alarm data and the present disclosure has no limit on it. In an embodiment, the alarm data may comprise the same type of alarm data such as HBF alarm data. The specific type of alarm may comprise any suitable type of alarm. For example, the alarm may be HBF alarm.

In an embodiment, the alarm data may comprise alarm data of a communication network. For example the communication network may be 3GPP network such as LTE or NR.

In an embodiment, the alarm data of the communication network may comprise heart beat failure (HBF) alarm data.

The network node may obtain the alarm data in various ways. For example, the network node may obtain the alarm data from a fault management system or a network management system which may manage the alarms from the NEs in a communication network. Alternatively the network node may obtain the alarm data from the NEs.

At block 304, the network node may detect an alarm flood of the alarm data.

For example, the network node may monitor the count of alarms (such as HBF alarms) and detect the alarm food using alarm flood detection model.

For example, an alarm flood has been defined by ANSI/ISA-18.2-2016, “Management of Alarm Systems for the Process Industries”, 2016, as being 10 or more annunciated alarms in any 10-minute period per operator. However, different operators may have their own definition on the alarm flood which may be accommodated to their service systems. To adapt different alarm flood detection requirements, the network node may provide different alarm flood detection options.

In an embodiment, the network node may detect the alarm flood of alarm data based on a threshold. The threshold may be set as any suitable value.

In an embodiment, the network node may detect the alarm flood of alarm data based on a machine learning (ML) algorithm.

The threshold-based method may allow users to define a fixed threshold to detect the alarm flood. This is a common method used in the real world. It is flexible and user oriented. The user can set and update the threshold based on their preference.

ML algorithm based method provides a self-adaptive algorithm to automatically detect the alarm flood. This method is appropriate to dynamic service systems, where the scale of the alarms keeps changing and users need a method to auto tune the alarm flood threshold.

The alarm flood detection can be formulated as the anomaly detection problem. It may adopt the SPOT as described in A. Siffer, P.-A. Fouque, A. Termier, and C. Largouet, “Anomaly detection in streams with extreme value theory,” in Proceedings of the 23rd ACM SIGKDD International Conference on Knowledge Discovery and Data Mining, 2017, pp. 1067-1075, to detect anomaly of the alarm (such as HBF alarm) count. Because SPOT detects the sudden change in time series via the extreme value theory, it accords with the characteristics of the alarm flood (such as HBF alarm flood). For each time point (set as 15 minutes in an embodiment), SPOT will generate a threshold based on the extreme value distributions of the past data. The time point, whose value is higher than the high threshold, will be treated as an anomaly.

At block 306, the network node may obtain data from at least one vendor related to the alarm data. For example the data collection module of FA of FIGS. 1-2 may obtain data from at least one vendor related to the alarm data.

The vendor can provide data related to the alarm data. The data provided by the vendor can be used to determine a root cause of the alarm flood of alarm data. For example, the root cause of the alarm flood of alarm data may be resided in the data from a vendor.

In an embodiment, the network node may obtain the data from the at least one vendor related to the alarm data regularly.

In an embodiment, the network node may obtain the data from the at least one vendor related to the alarm data when the alarm flood of the alarm data is detected.

To balance the delay of data collection and the effectiveness of the collected data, it may provide two approaches for data collection: regularly data collection or on demand data collection.

For example, regularly data collection may be applied to the data that is relatively stable in a long period. For example, location information (such as GPS (Global Position System) information), hardware (HW) version, NE type (such as eNB type), etc. Such data can be collected prior to the alarm flood using the regularly data collection task. This can highly reduce the data collection time when alarm flood occurs.

For example, on demand data collection may be applied to the data that may be dynamically changed over time. For example, environment data (such as weather data), traffic, network route, etc. Such data may be collected at the period of alarm flood.

For a cause isolation task, data may be the core of the success. If the root cause of the alarm flood of alarm data is resided in the data, the cause isolation model of FIGS. 1-2 can effectively achieve the goal. For each alarm flood (such as HBF alarm flood), the root cause may be different and resided in various data source from different vendors. This requires the network node to support data collection from multiple vendors. The network node may integrate various data collection methods to enlarge its root cause search space and improve the probability of finding the target root cause. These data collection methods may be derived from experienced engineers from different domains and cover the data for alarm, configuration, NE (such as eNB) diagnosis result and network diagnosis log, etc.

In an embodiment, the data from the at least one vendor may comprise at least one of network device configuration data, network device diagnosis result, network data, or environment data.

The network device may be any suitable device in the communication network, such as access network device or core network device. In an embodiment, the network device comprises a base station.

The environment data may comprise any suitable data (such as weather data) related to environment where the network device is located. In an embodiment, the environment data comprises at least one of a precipitation level, a wind level, or a temperature level.

The network device diagnosis result may comprise any suitable diagnosis result for example returned by a design script.

In an embodiment, the network device diagnosis result may comprise at least one of a network device diagnosis result during an alarm active period, or a network device diagnosis result during an alarm ceased period.

In an embodiment, the network device diagnosis result during the alarm active period comprises at least one of maintenance work checking of a network device, construction work checking of a network device, default router status checking of a network device, or traffic status checking in neighbor network device.

In an embodiment, the network device diagnosis result during the alarm ceased period comprises at least one of software crash event checking of a network device, restart event checking of a network device, upgrade event checking of a network device, local transmission issue checking of a network device, or remote transmission issue checking of a network device.

Take eNB diagnosis result as an example. If diagnosis actions are performed on eNB, it can help to isolate eNB specific problem. These diagnosis actions may be very useful for localizing the accurate root cause for a certain alarm (such as HBF alarm). However, manually performing these empirical diagnosis actions are time-consuming. Especially during the alarm flood, there are so many eNBs encountering a failure (such as HBF) during a short time period, it is almost impossible to perform the manually diagnosis actions to all the impacted eNBs.

To migrate the limitation of the manually diagnosis, the network node may automate the empirical diagnosis actions and initiatively collect the diagnosis result for cause isolation. The empirical diagnosis actions may be contributed by the experienced engineers.

FIG. 4 shows an example of eNB diagnosis actions according to an embodiment of the present disclosure.

As shown in FIG. 4, the eNB diagnosis actions may be divided into two phases: alarm active period diagnosis and alarm ceased period diagnosis.

When eNB encounters a failure (such as HBF), and the alarm (such as HBF alarm) is in active state, it is assumed that the eNB is unreachable. The automatic eNB diagnosis actions may be performed on the neighbor nodes or management nodes to identify the possible root cause. The detailed diagnosis actions are described as below.

Maintenance or Construction work checking: When eNB is under maintenance or construction, it is expected that the eNB will lost connection to the supervision node and result in alarm (such as HBF alarm). By checking the Maintenance or Construction work list in the management nodes, it can explore such case.

Default router status checking: Default router may be the closest node to the eNB. By checking the status of the default router, it can help to identify if the failure (such as HBF) is due to eNB issue or transmission issue.

Traffic status checking in neighbor eNBs: each eNB may be interacted with its neighbor eNBs to provide continuous service to user. By checking the traffic in neighbor eNBs that related to the failed eNB (such as HBF eNB), i.e. incoming or outgoing handover to or from the failed eNB, it can know whether the failed eNB is still taking traffic. This information can help to distinguish whether the failed eNB is under total outage or just lose connection to the supervision node only.

When the alarm (such as HBF alarm) is ceased for the eNB, it is assumed that the eNB is reachable again. The automatic eNB diagnosis actions are performed on the target eNB to identify the possible root cause by logining to the eNB and checking the desired log. The detailed diagnosis actions are described as below.

Software (S/W) crash event checking: A S/W crash event will cause eNB temporally unavailable and result in an alarm (such as HBF alarm). By checking the S/W crash event log in eNB, it can infer this reason.

Restart event checking: A restart event will cause eNB temporally unavailable and result in an alarm (such as HBF alarm). By checking the restart event log in eNB, it can infer this reason.

Upgrade event checking: An upgrade event will cause eNB temporally unavailable and result in an alarm (such as HBF alarm). By checking the upgrade event log in eNB, it can infer this reason.

Local transmission issue checking: If eNB encounters local transmission issue, the heartbeat message might be dropped in eNB and result in an alarm (such as HBF alarm). By checking the local transmission statistic in eNB, it can infer this reason.

Remote transmission issue checking: If eNB encounters remote transmission issue, the heartbeat message might be dropped in the network and result in an alarm (such as HBF alarm). By checking the remote transmission statistic in eNB, it can infer this reason.

There may be any other suitable diagnosis actions identified for troubleshooting. For example, as engineers get more and more familiar with their products, there will be more new diagnosis actions identified for troubleshooting. FA may provide a robust and flexible automatic diagnosis framework to integrate the new diagnosis actions.

The network device configuration data may comprise any suitable configuration data of the network device. In an embodiment, the network device configuration data comprises at least one of network device type, network device geographical information, network device property, network device scene property, electricity motor room that a network device is connected to, project that a network device belongs to, network device network mode, network device installation date, network device transmission mode, network device remote radio unit type, network device version, building that covered by a network device, or a distance between a network device and nearest coastline.

The network device property may comprise any suitable property. For example, when the network device is eNB, the station property of the eNB may comprise at least one of macro station, micro station, indoor station, relay, etc.

The network device scene property may indicate the scene of the network device. For example, when the network device is eNB, the scene property of the eNB may comprise at least one of expressway, hotel, ski resort, etc.

The project that a network device belongs to may indicate development project of the network device. For example, when the network device is eNB, the project that the eNB belongs to may comprise 5G stage 1, 4G stage 2, etc.

The network device network mode may indicate the network mode of the network node. For example, the network mode may comprise at least one of 5G, FDD(Frequency Division Duplexing)-1800, TDD(Time Division Duplex), etc.

The network device transmission mode may indicate the transmission mode of the network node. For example, the transmission mode for the eNB may comprise at least one of 10G_FULL, 1G_FULL, etc.

The network device remote radio unit type may indicate the remote radio unit type of the network device. For example, the type of remote radio unit for the eNB may comprise at least one of Radio2219, Radio4428, etc.

In an embodiment, the network device geographical information comprises at least one of a city that a network device locates, a district that a network device locates, or a geographical cluster identifier of a network device.

The network data may comprise any suitable network data such as route information, network congestion information, network load information, network dialog information, network measurement information, network maintenance information, etc. In an embodiment, the network data comprises at least one of network diagnosis log, an identity of a default router of a network device, or a name of a network management system that performs alarm data detection.

The network diagnosis log may comprise any suitable network diagnosis log which can be used to determine the alarm flood of alarm data. For example, the network diagnosis log may be generated by various network measure tools or network diagnosis tools.

In an embodiment, the network diagnosis log comprises node information in a path obtained by a network measurement tool.

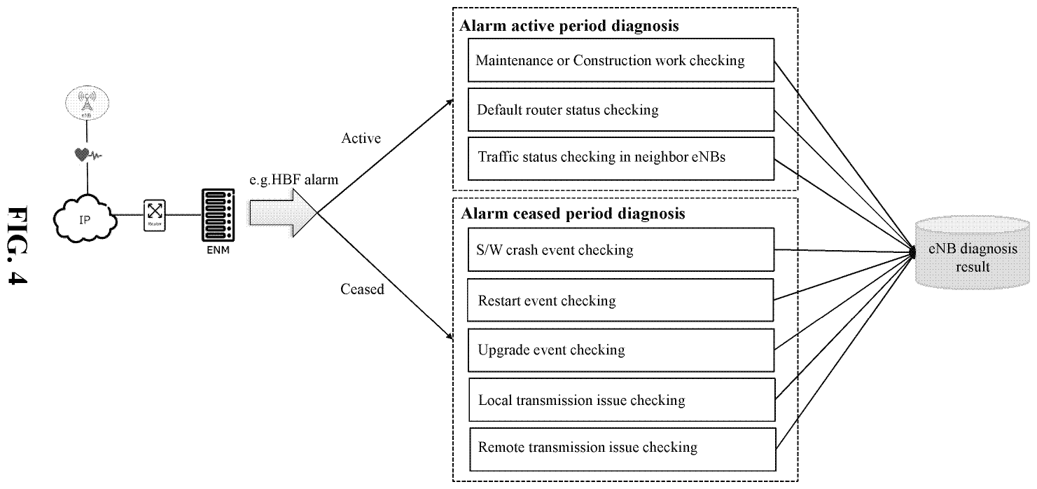

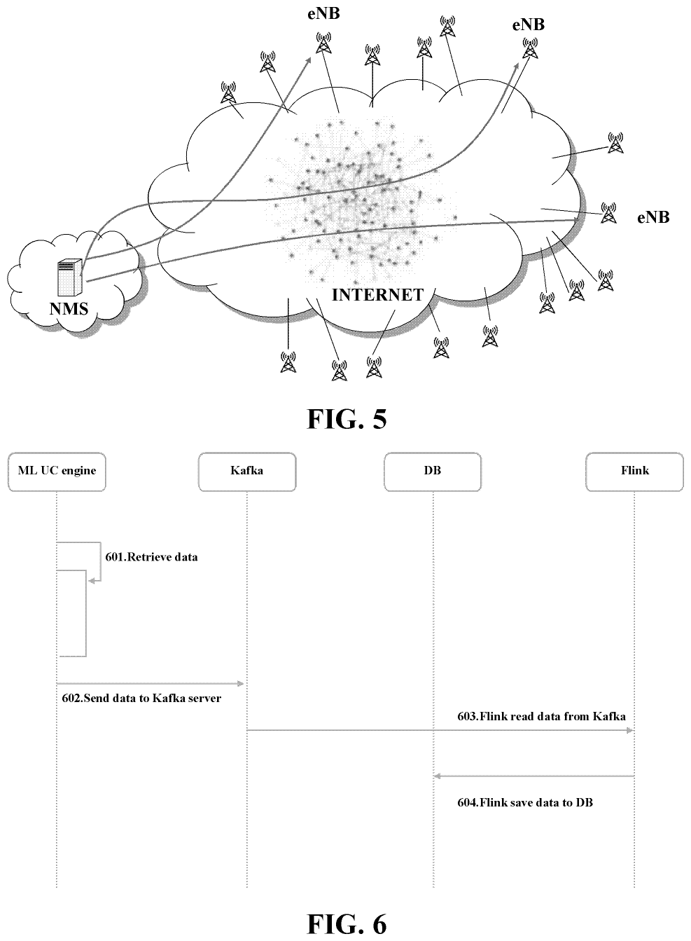

FIG. 5 shows an example of a telecommunication network according to an embodiment of the present disclosure.

Network problem may be a reason that causes the alarm flood (such as HBF alarm flood). The network topology between the NE (such as eNB) and the supervision node (such as NMS) may be complex, and many 3rd party nodes may be involved to provide the network service. When any node within the network is failed, it may result in the alarm flood (such as HBF alarm flood). However, diagnosing such network problem is usually difficult because the data of the 3rd party nodes are unavailable.

FA may make use of various network measurement tools (such as traceroute) and/or network diagnosis tools to retrieve node information in the public network. The node information may be further processed by FA to derive the common path information and common failed zone information of the NEs (such as eNBs) in an alarm flood (such as HBF alarm flood). This information can help engineers to isolate the problem to be a private network problem or a public network problem. And engineers can take next action accordingly.

FIG. 6 shows an example of data collection call flow according to an embodiment of the present disclosure.

In order to achieve the real time data collection and storage, FA makes use of the Apache Kafka and Apache Flink for streaming data processing. Apache Kafka is a distributed publish-subscribe messaging system and a robust queue that can handle a high volume of data and enables user to pass messages from one end-point to another. And Apache Flink is a framework for distributed data stream processing and batch processing. It supports window operations with event time and has the characteristics of sub-second low latency, high throughput, high performance and high fault tolerance.

At step 601. FA utilizes the ML UC engine to collect the data from different sources and store in the central data collection system. FA retrieves data from the central data collection system regularly.

At step 602. The data is then sent to Kafka server.

At step 603. Flink keeps monitoring the data in the Kafka server and automatically read the new data.

At step 603. Flink store the new data into the database (DB).

The data from different vendors may follow an uniform format or can be processed to the uniform format. For example, the data from different vendors may follow the uniform format or can be processed to the uniform format. An example of uniform format is as below.

$$〈 NE\_ID , Property A , Property B , Property C , … … 〉 \qquad ( 1 )$$

In this uniform format, each pattern data shall be attached to a dedicated NE (such as eNB). Please note that, various NE properties can be treated as the pattern data of a NE, such as the NE type, NE version, etc. For some data source, if direct mapping between the NE_ID and pattern data is not available, FA can internally reformat the data to the uniform format. For example, the collected weather may only have the city information but not the NE information. FA can firstly map the NE to the city and then use the city information to attach the corresponding weather data to the NE.

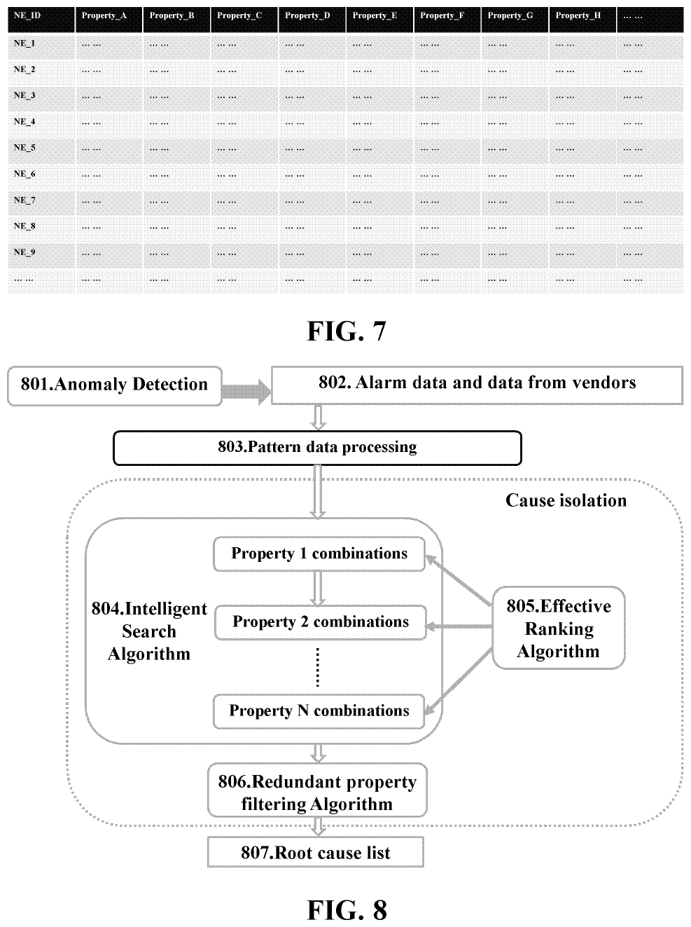

When all the pattern data are collected and reformatted to the uniform format, FA may use the NE_ID (e.g., eNB identifier) as the key to merge pattern data. Finally, each NE is associated with a long list of pattern data (e.g., property A, B, C . . . ). FIG. 7 shows an example of structure of the pattern data after consolidation according to an embodiment of the present disclosure.

FA supports data source from different vendors. For self-product, engineer can define dedicated data to be collected to the best of their domain knowledge. This can help to nail down the problem to a specific node or function, which can help for localizing the root cause. For other vendors' products, a strategy may be to isolate the problem to be this vendor or not. It is unnecessary to localize the detail error node or function in this vendor. Thus, no strong domain knowledge is required for other vendors' products. The engineers may only need to define the collection methods and all possible data will be collected for candidate dataset. FA is designed in a way that can accept large volume of data and process them in an effective manner.

Table 1 shows the pattern data collected from different vendors for alarm flood cause isolation. These pattern data may be designed based on the input from domain experts and they can cover the majority root cause of the alarm flood. Please note that, the pattern data can be flexibly extended if needed.

TABLE 1

| Property | vendor | Category | Description |
|---|---|---|---|
| enb_type | self-product | Configuration | The type of eNB, i.e. RBS6302, |
| | or other | | BB6318,etc |
| | vendor | | |
| city | self-product | Configuration | The city that the enb locates. |
| | or other | | |
| | vendor | | |
| district | self-product | Configuration | The district that the enb locates. |
| | or other | | |
| | vendor | | |
| geographical_cluster_id | self-product | Configuration | The auto-generated cluster id |
| | or other | | that are based on the enb's gps. |
| | vendor | | |
| enb_property | self-product | Configuration | The station property of the enb, |
| | or other | | i.e. macro station, micro station, |
| | vendor | | Indoor station. |
| scene_property | self-product | Configuration | The scene property of the enb, |
| | or other | | i.e. expressway, hotel, ski |
| | vendor | | resort, etc |
| electricity_motor_room | self-product | Configuration | The electricity motor room that |
| | or other | | the enb is connected to. |
| | vendor | | |
| project | self-product | Configuration | The project that the enb belongs |
| | or other | | to. i.e. 5G stage 1, 4G stage |
| | vendor | | 2, etc. |
| network_mode | self-product | Configuration | The mode of the network. i.e. |
| | or other | | 5G, FDD-1800, TDD, etc |
| | vendor | | |
| installation_date | self-product | Configuration | The date that the enb is setup. |
| | or other | | |
| | vendor | | |
| transmission_mode | self-product | Configuration | The transmission mode for the |
| | or other | | enb. i.e. 10G_FULL, |
| | vendor | | 1G_FULL, etc. |
| rru_type | self-product | Configuration | The type of rru for the enb. i.e. |
| | or other | | Radio2219, Radio4428, etc |
| | vendor | | |
| station_version | self-product | Configuration | The station version of the enb. |
| | or other | | |
| | vendor | | |
| building_coverage | self-product | Configuration | The buildings that are covered |
| | or other | | by the enb. |
| | vendor | | |
| coastline_distance | self-product | Configuration | The distance between the enb |
| | or other | | and the nearest coastline |
| | vendor | | |
| default_router | self-product | Network | The management gateway for |
| | or other | | the enb |
| | vendor | | |
| ser_name | self-product | Network | The NMS that performs the |
| | or other | | heartbeat checking |
| | vendor | | |
| network_diagnose_result | self-product | Network | The network diagnose result |
| | | | returned by design scripts |
| enb_diagnose_result | self-product | Other | The diagnose result returned by |
| | | | design scripts |
| precipitation | other vendor | Weather | The precipitation level during |
| | | | an alarm flood period |
| wind | other vendor | Weather | The wind level during an alarm |
| | | | flood period |
| temperature | other vendor | Weather | The temperature level during an |
| | | | alarm flood period |

Network_diagnose_result and enb_diagnose_result may be two important data sources that can be generated by automatic design scripts.

When an alarm flood (such as HBF alarm flood) is detected, the next step is to analyze the available pattern data to isolate the cause for the alarm flood. In the data collection phase, numerous pattern data has been collected for cause isolation. The numerous pattern data contain different properties and each property contains a lot of value (also referred as pattern). Manually analyzing such huge data is expensive and inefficient. FA provides an automated cause isolation model to help engineers effectively and efficiently identify the possible pattern combinations that can isolate the alarm flood.

With reference to FIG. 3, at block 308, the network node may determine at least one root cause of the alarm flood of alarm data based on the data from at least one vendor and the alarm data.

The network node may determine the at least one root cause of the alarm flood of alarm data using any suitable method, such as machine learning algorithm or data mining algorithm.

In an embodiment, the network node may generate respective list of pattern data for at least one alarm based on the data from at least one vendor and the alarm data. For example, the network node may generate similar structure of the pattern data as shown in FIG. 7. Based on the respective list of pattern data for at least one alarm, the network node may determine at least one pattern data combination that can characterize the alarm flood of the alarm data as the at least one root cause of the alarm flood of alarm data.

In an embodiment, the pattern data has a uniform format or is processed into the uniform format.

The network node may determine at least one pattern data combination using any suitable method such as machine learning algorithm or data mining.

For example, the cause isolation model of FIGS. 1-2 may be motivated by the engineers' experience for troubleshooting the alarm flood (such as HBF alarm flood). In traditional way, engineers will examine the properties (e.g., GPS location, default router, NE type, etc.) of each alarm (such as HBF alarm) in the alarm flood (such as HBF alarm flood), and identify the pattern combinations that can characterize the alarm flood (such as HBF alarm flood). Such pattern combinations, also referred as effective pattern combinations, are usually associated with the root cause thus can help engineers to isolate the problem. For example, if engineers identify that all failed NEs (such as eNBs) in a certain alarm flood are connected with the same default router, then there is high probability that the root cause is correlated with this default router. Engineers can further take action to check the status of this default router rather than examine each failed NE separately.

In an embodiment, the network node may filter out irrelevant pattern combination by using abnormal period data.

In an embodiment, the network node may filter out pattern combination with a low frequency of occurrence.

In an embodiment, the network node may determine respective score of respective candidate pattern combination based on a distribution difference of the respective candidate pattern combination between normal period data and abnormal period data as well as an distribution of the respective candidate pattern combination in the abnormal period data. Based on the respective score of respective candidate pattern combination, the network may determine at least one pattern data combination with a score above a threshold as the at least one root cause of the alarm flood of alarm data. The threshold may be set as any suitable value. For example, engineers can set and update the threshold based on their preference or experience, etc.

In an embodiment, the network node may filter out redundant pattern data from the at least one pattern data combination based on redundant relationship of a pair of pattern data.

For example, the cause isolation model of FIGS. 1-2 may be used to solve the problem of root cause localization in large dataset. There may be some challenges as below.

The first challenge is huge search space. The root cause could be any combination of the properties and property patterns. Assume there are 10 properties and each property has 10 patterns, then the number of candidate pattern combinations could be 10¹⁰. As the number of properties is increased, the number of candidate pattern combinations will be increased exponentially.

The second challenge is to define effective score metric. Alarm data is usually difficult to be predicted and the data volume of alarm is small. This brings great challenge to defining an effective score metric for each candidate pattern combination.

The third challenge is existence of redundant properties. FA will collect as many pattern data as possible so as to enlarge its root cause search space and improve the probability of finding the target root cause. The pattern data come from different vendors. There is no domain knowledge to those pattern data from other vendors. It is possible that the collected pattern data contains redundant information. The redundant properties tend to have similar ranking score and appear in the final root cause list together. For example, some vendors can provide both the “city name” and “city ID” as the properties for a NE (such as eNB). If the “city name” come out to be the root cause, then “city ID” will also appear to be the root cause. With domain knowledge, human can figure out the “city name” is duplicated with “city ID”. However, the machine itself does not have such knowledge. As a result, the final root cause list will potentially contain redundant properties, which weakens the succinctness of the root cause list.

To address the above challenges, the pattern data cause isolation model is developed to properly handle the alarm flood scenario (such as HBF alarm flood scenario). The contributions of cause isolation model are described as below.

To address the first challenge, an irrelevant pattern combinations filtering and explanatory power based pruning technique may be applied to reduce the search space.

To address the second challenge, it introduces an effective score metric, naming distribution_based score. The core idea of the distribution_based score is to evaluate the distribution difference between the normal period data and abnormal period data as well as the distribution in the abnormal period data for an candidate effective pattern combination. The distribution based score tends to give high ranking score to the candidate effective pattern combination that have large portion in abnormal period data and small portion in normal period data.

To address the third challenge, it introduces a new property redundant matrix to filter the redundant properties in the final root cause list.

The solution of cause isolation model in FA may comprise three algorithms: candidate effective pattern combination search algorithm, candidate effective pattern combination ranking algorithm and redundant property filtering algorithm. The problem of alarm flood cause isolation problem may be formulated as a pattern mining problem. Given a alarm flood is detected over a period of time, the goal is to search for the effective pattern combinations that can characterize the alarm flood (such as HBF alarm flood). But unlike the simple frequent itemset mining approaches as described in J. Han and M. Kamber. Data Mining: Concepts and Techniques. Morgan kaufmann, 2006, the proposed solution not only mine the common pattern from the properties, but also take into account the temporal information of the properties. Only those pattern combinations whose frequencies change significantly from normal period to the alarm flood period will be picked up as the effective pattern combinations. The proposed solution also introduces an effective score metric and redundant property redundant matrix which can help accurately identify the potential root cause set.

FIG. 8 shows an flowchart of cause isolation model according to an embodiment of the present disclosure.

The goal of the cause isolation model is to search for the effective pattern combinations that can characterize the alarm flood (such as HBF alarm flood).

At step 801. The anomaly detection module detects alarm flood of alarm data, which will trigger step 802.

At step 802. Alarm data and data from vendors are sent to pattern data processing module.

At step 803. pattern data processing module processes the alarm data and the data from vendors.

At step 804. Intelligent Search Algorithm is performed on the processed data.

At step 805. Effective Ranking Algorithm is performed on the property combinations.

At step 806. Redundant property filtering Algorithm is performed on the output of the Effective Ranking Algorithm

At step 807. Root cause list is provided.

Following sections will describe each algorithm in detail.

### Candidate Effective Pattern Combination Search Algorithm

A challenge of root cause localization is its huge search space due to the large number of pattern combinations. As in the context of alarm food problem, the pattern combinations appeared in the abnormal period may be the potential root cause. Thus it can use the abnormal period data to filter out the irrelevant pattern combinations.

For the remained pattern combinations, the explanatory power based pruning technique may be applied to further reduce the search space. Explanatory power of a pattern is defined as the fraction of the pattern in the data. The explanatory power of an pattern j in property i may be defined as formula 2:

$${EP}_{ij} = \frac{number of failed NEs with pattern i in property j}{number of failed NEs} \qquad ( 2 )$$

The explanatory power can be used to filter out the pattern combinations with low frequency of occurrence.

### Candidate Effective Pattern Combination Ranking Algorithm

In order to achieve an accurate evaluation of probability to be the root cause, it proposes a novel score metric named distribution_based score, which adopts the distribution difference between the normal period data and abnormal period data as well as the distribution in the abnormal period data to evaluate each candidate effective pattern combination. The distribution_based score may be defined as below formula:

$$S = max ( {p}_{i} * \sqrt[2]{{p}_{i} - {q}_{i}} - β * ( {N}_{root} - 1 ) , 0 ) \qquad ( 3 )$$

Where, pᵢ is the candidate effective pattern combination proportion in abnormal period. qᵢ is the candidate effective pattern combination proportion in normal period. β*(Nᵣₒₒₜ−1) is a restriction factor that is added to limit the number of property patterns within the effective pattern combination. According to Occam's Razor theory, the most likely explanation for an event is usually the simplest explanation. Thus, the succinctness of the effective pattern combination should also be considered. Here, Nᵣₒₒₜ is the number of property patterns within the effective pattern combination, and β is an empirical parameter, where may be set to 0.1 or any other suitable value. The formula 3 tends to elect the effective pattern combination that is with high explanatory power as well as large distribution change from normal period to abnormal period.

### Redundant Property Filtering Algorithm

The collected data can have redundant properties. Those redundant properties may appear together in the final root cause list, which weakens the succinctness of the root cause list. Ideally, it shall filter out those redundant properties based on the domain knowledge provided by the experts. However, this domain knowledge cannot easily be retrieved, especially for other vendors' data. In the proposed solution, it proposes a novel way to automatically derive the relationship between each pair of properties.

Formally, it can define that property j is redundant to property i if for each unique pattern value in property i, there is also unique pattern value in j that connects to property i. We use redundant coefficient Cᵢⱼ to express such redundant relationship. Cᵢⱼ may be in range of (0, 1], where 1 indicates high redundant while 0 indicates low redundant. For example, “city name” and “city ID” shall be high redundant and their redundant coefficient shall equal to 1. Unlike other correlation coefficient (e.g., Pearson, Kendall Rank, etc.), this redundant coefficient is asymmetrical. This means if property j is highly redundant to property i, it doesn't indicate property i is highly redundant to property j too. Taking “city name” and “province name” as an example, since each city belongs to a unique province, the “province name” is redundant to “city name”. That means, if root cause come out to be a specific city, it can localize the target area with the city name. The province name for that city is redundant. However, the “city name” is not redundant to “province name”. Because a province contains multiple cities, knowing only the province name can not localize the area of the city.

According to above principle, it can define following formula to calculate the redundant coefficient for each property pair.

$${c}_{ij} = \frac{{\sum }_{k = 0 \frac{1}{{u}_{jk}}}^{{u}_{i}}}{{u}_{i}} \qquad ( 4 )$$

Where, uᵢ is the count of the unique value of property i, excluding the single occurrence. uⱼₖ is the count of the unique value of property j for the k_th unique value counted by uᵢ. All the property pairs together build up the property redundant matrix C.

$$C = [ \begin{matrix}{c}_{11} & … & {c}_{1 N} \\ ⋮ & ⋱ & ⋮ \\ {c}_{N 1} & … & {c}_{NN}\end{matrix} ] \qquad ( 5 )$$

The property redundant matrix C will be calculated with full property data at the beginning of the cause isolation model. And it will be used to filter out the redundant properties in the final root cause list. The filtering logic is that, when there are two highly redundant properties appeared in the final root cause list, only the property with the highest distribution_based score will be kept. The other one will be filtered out from the root cause list.

The pseudo code of the cause isolation algorithm may be as following.

```
Input:
All the alarm count of patterns
ST: Score Threshold
EPT: Explanatory Threshold
Beta: Parameter to control the number of pattern in a combination
C: Property redundant matrix
Output:
CandidateSet: Effective Pattern Combinations
Procedure:
CandidateSet = [ ]
For each i ϵ D, // each property
  E_set=[ ]
  bc =NA
  for each j ϵ i: // each pattern in i property
        if j in abnormal period data:
              if EPᵢⱼ > EPT:
                  E_set.add +=j
    for each e ϵ combination (E_set ): // each pattern combination
          calculate the distribution_based score Sₑ
          if Sₑ > ST:
            if bc ==NA:
                bc = e
              else:
                  if Sₑ> S_{bc}:
                    bc = e
      CandidateSet + = bc
For each candidate property k in CandidateSet:
    For each candidate property l after k in CandidateSet:
            If Cₖₗ >90%, delete l
Return CandidateSet
Final = CandidateSet.SortDescend (S)
Return Final.Take(3) // Top 3 most potential set
```

In an embodiment, a visualization interface may be provide to demonstrate the alarm (such as HBF alarm) trend and cause isolation result. The visualization interface may contain any suitable information.

For example, the visualization interface may contain the following information.

Alarm trend: which may be a curve graph that shows the alarm trend in a network.

Active alarm information: which may be a pie chart and a map figure that show the active alarm in the network

Anomaly list: which may be a table that shows the alarm flood occurrence in the network.

Cause isolation result: which may be a tab that shows the output of the cause isolation model which includes the location of the alarms (such as HBF alarms) in the map, the top 3 (or other number) effective pattern combinations, the distribution of the top contribution properties and the detail information of each alarm.

In an embodiment, the proposed solution is applied to the fault management system in a big communication network to detect the alarm flood and perform corresponding cause isolation, and the proposed solution may use about 15-minutes' interval to detect the alarm flood and provides a near real time cause isolation. By inviting experienced engineers to review the result of the proposed solution, the feedback shows that the cause isolation result can achieve similar accuracy as manual diagnosis but save the human efforts significantly.

According to various embodiments, the proposed solution creates a novel way to solve the alarm flood (HBF alarm flood) in a network.

In some embodiments herein, the proposed solution supports collecting data from multiple vendors.

In some embodiments herein, user does not need to have strong knowledge on other vendors' data.

In some embodiments herein, the data once collected, can be normalized to standard format and further used by cause isolation model.

In some embodiments herein, the proposed solution can use an intelligent cause isolation model to mine the root cause from numerous data. Cause isolation model is appropriate to numerous data and can provide very fast cause isolation. Thus, it can greatly reduce the human effort on analyzing the data.

In some embodiments herein, the proposed solution provides a common framework for network level failure cause isolation, integrating data collection, anomaly detection, pattern data generation and cause isolation etc., which can handle the alarm/event/KPI (Key Performance Indicator) anomaly flood in loosely coupled scenario.

Embodiments herein afford many advantages, of which a non-exhaustive list of examples follows. In some embodiments herein, the proposed solution has effectiveness. The proposed solution doesn't seek to use single data source from single vendor to explain the root cause of an alarm flood (such as HBF alarm flood). Instead, it provides a data collection framework to adopt different data source from different vendors. This overcomes the weakness that single data source may not be able to explain a certain alarm flood (such as HBF alarm flood). The framework leverages the knowledge from different domains, which can identify root cause more accurately.

In some embodiments herein, the proposed solution has efficiency. The proposed solution adopts numerous data for cause isolation. This will result in a very large root cause search space. Manually analysis for these huge data is impossible. The proposed solution introduces a high-efficiency cause isolation model to analyze the data. It only requires a few seconds for the root cause analysis, which highly reduces the human effort and time of trouble shooting.

In some embodiments herein, the proposed solution has applicability. The proposed solution provides a general framework for alarm flood cause isolation in loosely coupled scenario. The framework once built up, can be reused by various alarm/KPI/event anomaly flood with just re-defining the type of alarm/KPI/event anomaly flood to monitor and some of data source for effective pattern combinations searching.

The embodiments herein are not limited to the features and advantages mentioned above. A person skilled in the art will recognize additional features and advantages upon reading the following detailed description.

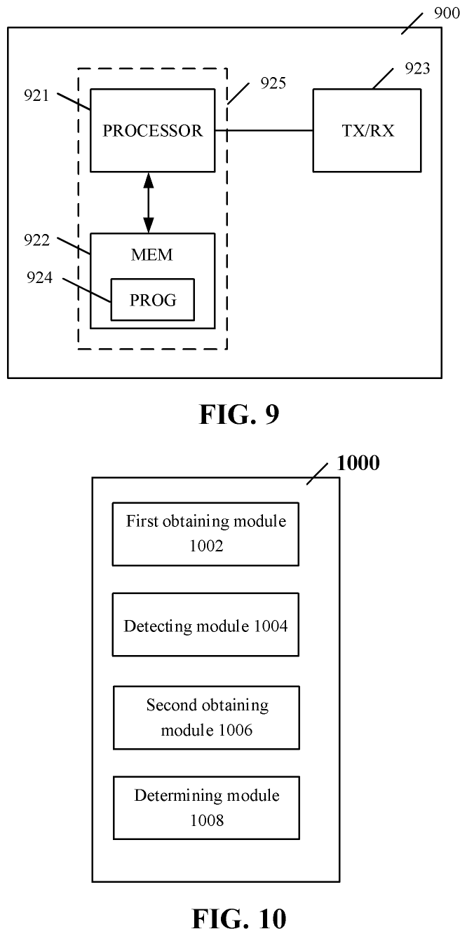

FIG. 9 is a block diagram showing an apparatus suitable for practicing some embodiments of the disclosure. For example, the network node described above may be implemented as or through the apparatus 900.

The apparatus 900 comprises at least one processor 921, such as a digital processor (DP), and at least one memory (MEM) 922 coupled to the processor 921. The apparatus 920 may further comprise a transmitter TX and receiver RX 923 coupled to the processor 921. The MEM 922 stores a program (PROG) 924. The PROG 924 may include instructions that, when executed on the associated processor 921, enable the apparatus 920 to operate in accordance with the embodiments of the present disclosure. A combination of the at least one processor 921 and the at least one MEM 922 may form processing means 921 adapted to implement various embodiments of the present disclosure.

Various embodiments of the present disclosure may be implemented by computer program executable by one or more of the processor 921, software, firmware, hardware or in a combination thereof.

The MEM 922 may be of any type suitable to the local technical environment and may be implemented using any suitable data storage technology, such as semiconductor based memory devices, magnetic memory devices and systems, optical memory devices and systems, fixed memories and removable memories, as non-limiting examples.

The processor 921 may be of any type suitable to the local technical environment, and may include one or more of general purpose computers, special purpose computers, microprocessors, digital signal processors (DSPs) and processors based on multicore processor architecture, as non-limiting examples.

In an embodiment where the apparatus is implemented as or at the network node, the memory 922 contains instructions executable by the processor 921, whereby the network node operates according to any step of the methods related to the network node as described above.

FIG. 10 is a block diagram showing a network node according to an embodiment of the disclosure. As shown, the network node 1000 comprises a first obtaining module 1002 configured to obtain alarm data comprising a specific type of alarm. The network node 1000 further comprises a detecting module 1004 configured to detect an alarm flood of the alarm data. The network node 1000 further comprises a second obtaining module 1006 configured to obtain data from at least one vendor related to the alarm data. The network node 1000 further comprises a determining module 1008 configured to determine at least one root cause of the alarm flood of alarm data based on the data from at least one vendor and the alarm data.

The term unit or module may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

With function units, the network node may not need a fixed processor or memory, any computing resource and storage resource may be arranged from the network node in the communication system. The introduction of virtualization technology and network computing technology may improve the usage efficiency of the network resources and the flexibility of the network.

According to an aspect of the disclosure it is provided a computer program product being tangibly stored on a computer readable storage medium and including instructions which, when executed on at least one processor, cause the at least one processor to carry out any of the methods as described above.

According to an aspect of the disclosure it is provided a computer-readable storage medium storing instructions which when executed by at least one processor, cause the at least one processor to carry out any of the methods as described above.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function or means that may be configured to perform one or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1-23. (canceled)

24. A method performed by a network node, comprising:
obtaining alarm data comprising a specific type of alarm;
detecting an alarm flood of the alarm data;
obtaining data from at least one vendor related to the alarm data; and
determining at least one root cause of the alarm flood of alarm data based on the data from at least one vendor and the alarm data.

25. The method of claim 24, wherein detecting an alarm flood of alarm data comprises at least one of:
detecting the alarm flood of alarm data based on a threshold, or
detecting the alarm flood of alarm data based on a machine learning algorithm.

26. The method of claim 24, wherein the alarm data comprises alarm data of a communication network.

27. The method of claim 26, wherein the alarm data of the communication network comprises heart beat failure alarm data.

28. The method of claim 24, wherein obtaining data from at least one vendor related to the alarm data comprises at least one of:
obtaining the data from the at least one vendor related to the alarm data regularly, or
obtaining the data from the at least one vendor related to the alarm data when the alarm flood of the alarm data is detected.

29. The method of claim 24, wherein the data from the at least one vendor comprises at least one of:
network device configuration data,
network device diagnosis result,
network data, or
environment data.

30. The method of claim 29, wherein the network device configuration data comprises at least one of:
network device type,
network device geographical information,
network device property,
network device scene property,
electricity motor room that a network device is connected to,
project that a network device belongs to,
network device network mode,
network device installation date,
network device transmission mode,
network device remote radio unit type,
network device version,
building that covered by a network device, or
a distance between a network device and nearest coastline.

31. The method of claim 30, wherein the network device geographical information comprises at least one of:
a city that a network device locates,
a district that a network device locates, or
a geographical cluster identifier of a network device.

32. The method of claim 29, wherein the network data comprises at least one of:
network diagnosis log,
an identity of a default router of a network device, or
a name of a network management system that performs alarm data detection.

33. The method of claim 32, wherein the network diagnosis log comprises node information in a path obtained by a network measurement tool.

34. The method of claim 29, wherein the network device comprises a base station.

35. The method of claim 29, wherein the environment data comprises at least one of:
a precipitation level,
a wind level, or
a temperature level.

36. The method of claim 29, wherein the network device diagnosis result comprises at least one of:
a network device diagnosis result during an alarm active period, or
a network device diagnosis result during an alarm ceased period.

37. The method of claim 36, wherein the network device diagnosis result during the alarm active period comprises at least one of:
maintenance work checking of a network device,
construction work checking of a network device,
default router status checking of a network device, or
traffic status checking in neighbor network device.

38. The method of claim 36, wherein the network device diagnosis result during the alarm ceased period comprises at least one of:
software crash event checking of a network device,
restart event checking of a network device,
upgrade event checking of a network device,
local transmission issue checking of a network device, or
remote transmission issue checking of a network device.

39. The method of claim 24, wherein determining at least one root cause of the alarm flood of alarm data based on the data from at least one vendor and the alarm data comprises:
generating respective list of pattern data for at least one alarm based on the data from at least one vendor and the alarm data; and
based on the respective list of pattern data for at least one alarm, determining at least one pattern data combination that can characterize the alarm flood of the alarm data as the at least one root cause of the alarm flood of alarm data.

40. The method of claim 39, wherein the pattern data has a uniform format or is processed into the uniform format.

41. The method of claim 39, wherein determining the pattern data combination comprises:
determining respective score of respective candidate pattern combination based on a distribution difference of the respective candidate pattern combination between normal period data and abnormal period data as well as an distribution of the respective candidate pattern combination in the abnormal period data; and
based on the respective score of respective candidate pattern combination, determining at least one pattern data combination with a score above a threshold as the at least one root cause of the alarm flood of alarm data.

42. A network node, comprising:
a processor; and
a memory coupled to the processor, said memory containing instructions executable by said processor, whereby said network node is operative to:
obtain alarm data comprising a specific type of alarm;
detect an alarm flood of the alarm data;
obtain data from at least one vendor related to the alarm data; and
determine at least one root cause of the alarm flood of alarm data based on the data from at least one vendor and the alarm data.

43. A non-transitory computer-readable storage medium storing instructions configured so as to, when executed by at least one processor, cause the at least one processor to:
obtain alarm data comprising a specific type of alarm;
detect an alarm flood of the alarm data;
obtain data from at least one vendor related to the alarm data; and
determine at least one root cause of the alarm flood of alarm data based on the data from at least one vendor and the alarm data.
